(19) United States
(12) Patent Application Publication
(10) Pub. No.: US 2010/0109981 A1
(43) Pub. Date: May 6, 2010

(54) CUT-TO-MEASURE DISPLAY DEVICE AND METHOD FOR CONTROL THEREOF

(76) Inventors: Rabin Bhattacharya, Eindhoven (NL); Liesbeth Van Pieterson, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 12/532,425

(22) PCT Filed: Mar. 25, 2008
(86) PCT No.: PCT/IB08/51091

§ 371 Date: Sep. 22, 2009

(30) Foreign Application Priority Data
Mar. 29, 2007 (EP) 07105197.3

(51) Int. Cl. G09G 3/20

(52) U.S. Cl. 345/55

(57) ABSTRACT

A cut-to-measure display device (100) comprising a plurality of pixel groups (200-223), each including a plurality of individually controllable pixels, and a pixel group controller (230) adapted to control each of the pixels in the pixel group (200-223). The cut-to-measure display device (100) further comprises a display controller (235) configured to control the pixels, via the pixel group controllers (230), to display an image corresponding to pre-determined image data, and a communication bus (236) comprising a plurality of bus lines (301, 304) interconnecting the display controller (235) with each of the pixel group controllers (230). Each of the pixel group controllers (230) is configured to determine locations of functional pixels in its associated pixel group (200-223), and communicate information indicative of the locations of functional pixels to the display controller (235) to enable adjustment of the image data for display of the image by means of the functional pixels.

### TECHNICAL FIELD OF THE INVENTION

The present invention relates to a cut-to-measure display device, and to a method for controlling such a display device.

### TECHNICAL BACKGROUND

In a growing number of applications, there is an increased demand for customized displays. In particular, a wide range of different display sizes are desired.

One approach for fulfilling this demand is to provide so-called cut-to-measure display devices, which can, as the name implies, be adapted to the required size. Such display devices may be based on any rigid or flexible substrate, one especially interesting area being textile-based display devices. Such display devices are typically based on interwoven electrically conductive and non-conductive yarns.

US 2006/0035554 discloses a cut-to-measure display device in which each pixel has a microelectronic component for electronic data processing. These microelectronic components exchange electronic messages with each other to enable self-organization to thereby adapt the display device to a particular size obtained through “cut-to-measure”.

A drawback of the display device disclosed in US 2006/0035554 is that a large number of microelectronic devices capable of processing and data-communication are required, which detrimentally influences the cost of the display device, especially for large area displays.

### SUMMARY OF THE INVENTION

In view of the above-mentioned and other drawbacks of the prior art, a general object of the present invention is to provide an improved cut-to-measure display device, in particular enabling a lower cost of the display device.

According to a first aspect of the present invention, these and other objects are achieved through a cut-to-measure display device comprising a plurality of pixel groups, each including a plurality of individually controllable pixels, and a pixel group controller adapted to control each of the pixels in the pixel group, a display controller configured to control the pixels, via the pixel group controllers, to display an image corresponding to pre-determined image data, and a communication bus comprising a plurality of bus lines interconnecting the display controller with each of the pixel group controllers, wherein each of the pixel group controllers is configured to determine locations of functional pixels in its associated pixel group and communicate information indicative of the locations of functional pixels to the display controller to enable adjustment of the image data for display of the image by means of the functional pixels.

The cut-to-measure display device may be based on a rigid or flexible substrate. In a particularly advantageous embodiment, the substrate is a fabric.

By grouping the pixels in the display device in pixel groups, each having an associated pixel group controller being interconnected with the display controller via a communication bus, the display controller can determine which pixel group controllers are still addressable after the display device has been cut to the desired shape. This provides a partial cut-to-measure functionality, since the display controller is enabled to adapt the image data to the still addressable pixel group controllers.

In order to further improve the cut-to-measure functionality, each pixel group controller in the display device according to the present invention is additionally adapted to determine locations of functional pixels in its associated pixel group and to communicate these locations to the display controller. Hereby, the display controller can get access to exactly which pixels in the cut display device are functional. The image data can then be adapted to these pixels such that the desired image can be displayed by the display device practically regardless of the shape and size into which it has been cut.

The locations of functional pixels can, for example, be determined by successively addressing each pixel and determining if that pixel is functional by evaluating at least one electrical characteristic of the pixel. Such electrical characteristics may include, for example, impedance, threshold voltage, time constant etc.

The present invention is equally applicable to the alternative case, in which the substrate is first cut to measure and electronic components subsequently mounted on the substrate. Also in this case, configuring the pixel group controllers according to the present invention enables adjustment of the image data for display of the image by means of the pixels that have been determined to be functional.

Accordingly, a very large degree of tolerance and adaptability with respect to cut-to-measure shape and size is achieved without having to resort to equipping every pixel with a microprocessor. Hereby, improved cost-efficiency is achieved as compared to the prior art.

Furthermore, the pixels can be made smaller since each pixel no longer has to accommodate a microelectronic circuit having processing and communication capabilities. Thus, the present invention enables a cut-to-measure display having a higher resolution.

Moreover, each of the bus lines may, advantageously, be formed by a set of mutually interconnected conductors distributed across the display device to enable a robust interconnection between the display controller and the pixel group controllers.

The set of mutually interconnected conductors may, for example, be provided in the form of a conductive mesh, and the respective conductor sets associated with each bus line are, obviously, electrically separated from each other. This may preferably be achieved by forming the conductor sets in different layers of the substrate on which the display device is based.

By forming each bus line as a set of mutually interconnected conductors, a large number of connection paths between the display controller and each pixel group controller is provided. Hereby, the communication bus becomes very robust to cuts in the display device. In other words, even if many of the connection paths leading to a certain pixel group controller are broken, there is a high probability that some connection paths will remain so that the pixel group controller will still be addressable.

The bus line may, advantageously, be a serial bus having a clock line and a data line.

Furthermore, each pixel group controller may have a pre-determined address on the bus.

Additionally, each pixel in the cut-to-measure display device according to the present invention, may comprise at least one light-emitting device.

According to one embodiment, each pixel comprised in the cut-to-measure display device of the present invention may comprise a first sub-pixel addressable by a first row selection line and each of a first and a second column selection lines, and a second sub-pixel addressable by a second row selection line and each of a first and a second column selection lines.

Hereby, each pixel group becomes more robust to cuts, since such a pixel will still be functional even if one of the sub-pixels stops working or becomes disconnected and/or one of the row selection lines is cut and/or one of the column selection lines is cut.

Each sub-pixel comprised in this pixel may further include a light-emitting device, such as a light-emitting diode, and the pixel may comprise a resistor connecting the first and second row selection lines.

This makes the pixel even more robust to faults, since the resistor enables the pixel to continue to function even if one of the light-sources in a pixel stops working and the row selection line associated with the other light-source is cut. In this case, the current will pass in the row selection line associated with the broken light-source and then continue through the resistor to feed the other light-source, causing it to emit light (when addressed).

Obviously, the same effects as those described above are obtained if the words “row” and “column” above are interchanged.

Furthermore, the pixel group controller may be configured to apply a control voltage alternatingly to the first and second row selection lines, thereby alternatingly selecting the first and second sub-pixels comprised in the pixel.

In this manner the intensity of light emitted by a pixel can remain substantially unchanged even if any of the above-mentioned fault conditions should occur. In other words, the display device according to the invention is capable of passively correcting for virtually any electrical or mechanical fault condition.

Additionally, the pixel group controller may comprise a plurality of pixel drivers, each being configured to drive a sub-set of the pixels comprised in the pixel group.

The display device according to the present invention may, furthermore, advantageously comprise a textile formed from interwoven electrically conductive and non-conductive yarns, each of the bus lines is formed by a matrix of conductive warp and weft yarns crossing each other such that electrical contact is achieved there between, and the row and column selection lines, respectively, may be formed by conductive warp and weft yarns crossing each other such that the warp and weft yarns are electrically isolated from each other.

According to a second aspect of the present invention, the above-mentioned and other objects are achieved through a method for controlling a cut-to-measure display device having a plurality of pixel groups, each including a plurality of individually controllable pixels, and a pixel group controller adapted to control each of the pixels in the pixel group, a display controller configured to control the pixels, via the pixel group controllers, to display an image corresponding to pre-determined image data, and a communication bus comprising a plurality of bus lines interconnecting the display controller with each of the pixel group controllers, the method comprising the steps of for each pixel group, determining whether its associated pixel group controller is addressable, for each of the addressable pixel group controllers, acquire information indicative of functional pixels in its associated pixel group, adjusting the image data based on the information, and controlling the functional pixels, via the addressable pixel group controllers, to display the image.

Effects and features of the present second aspect of the present invention are largely analogous to those described above in connection with the first embodiment.

### BRIEF DESCRIPTION OF THE DRAWINGS

These and other aspects of the present invention will now be described in more detail, with reference to the appended drawings showing a currently preferred embodiment of the invention, wherein:

FIG. 1 schematically illustrates an embodiment of a cut-to-measure display device according to the present invention before it has been cut;

FIG. 2 schematically shows a portion of the cut-to-measure display in FIG. 1 as it will appear after the cut has been made, but before the cut-out portion of the display has been separated from the remainder;

FIG. 3 schematically illustrates a robust communication bus structure for enabling robust communication between the display controller and the pixel group controllers;

FIG. 4 is a circuit diagram schematically illustrating an exemplary pixel configuration;

FIG. 5 is a circuit diagram schematically illustrating an exemplary pixel row driver configuration;

FIG. 6 is a block diagram schematically illustrating an exemplary pixel group arrangement; and

FIG. 7 is a flow chart schematically illustrating a preferred embodiment of the method according to the present invention.

### DETAILED DESCRIPTION OF A PREFERRED EMBODIMENT OF THE INVENTION

In the following description, the present invention is described with reference to a simplified cut-to-measure display device having a very limited number of pixels. Furthermore, each pixel is constituted by two light-emitting diodes (LEDs) and one resistor.

It should be noted that this by no means limits the scope of the invention, which is equally applicable to cut-to-measure display devices having other pixel group configurations, as well as other pixel layouts. In particular, other types of light-sources, such as fluorescent lamps may be used.

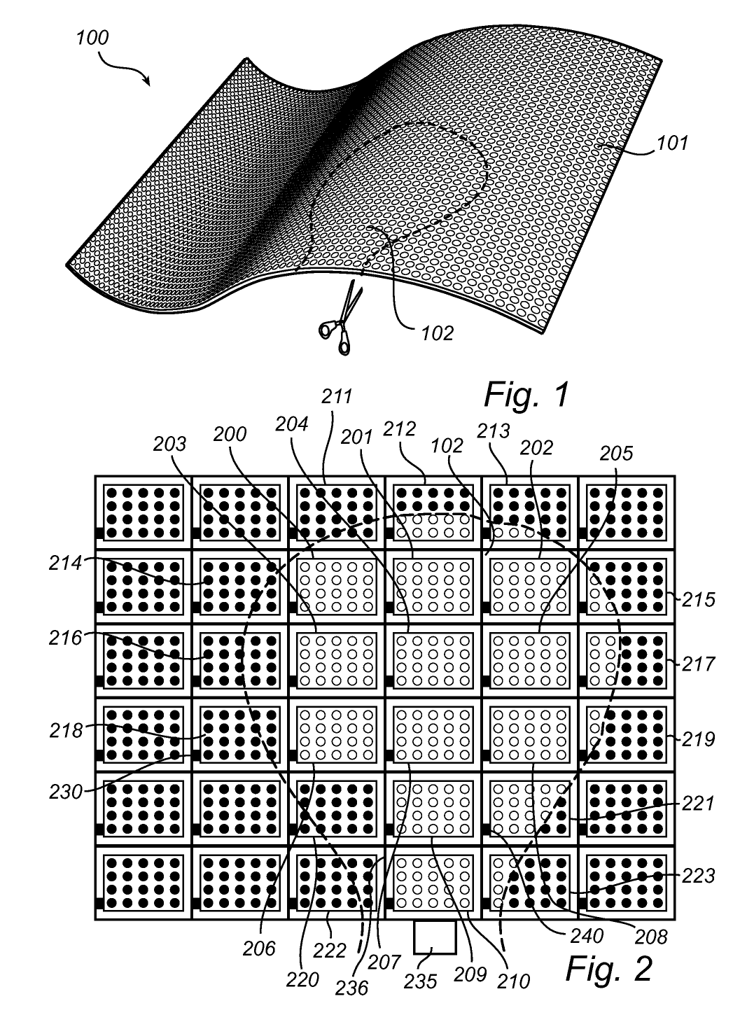

FIG. 1 schematically illustrates an embodiment of a cut-to-measure display device according to the present invention before it has been cut, where the display device 100 is shown as a large, flexible sheet having a plurality of pixels 101 (only one of these is indicated for the sake of clarity of drawing). This sheet may, for example, be a woven fabric in which the pixels 101 are addressable through conductive yarns interwoven in the fabric. In FIG. 1, an exemplary cut is indicated by the dashed line, separating a cut-out display device 102 from the remainder of the sheet 100.

In FIG. 2, a close-up of the cut-out display device 102 is schematically illustrated. As shown in FIG. 2, the display device 102 comprises 11 intact pixel groups 200-210, and 13 pixels groups 211-223 that have been cut through when cutting out the display device 102. Each pixel group 200-223 has, in the present example, one pixel group controller (indicated by the filled squares in FIG. 2) and 20 pixels, each controlled by their respective pixel group controller.

Through the cut illustrated by the dashed line, a number of the pixel group controllers 230 (only one is indicated for the sake of clarity of drawing) have been separated from the display controller 235 since the bus lines 236 (here indicated by one matrix only) leading to these pixel group controllers 230 have been severed.

In the presently illustrated example, each pixel group has one pixel group controller, and this pixel group controller is positioned in the lower left corner of the surface occupied by the respective pixel group. A number of modifications are possible in order to make the display device 102 even more robusts to cuts of the bus lines 236. For example, each pixel group may have several pixel group controllers which are connected to the bus lines 236 on different sides of their respective pixel groups. Furthermore, the pixel group controllers may be attached to the substrate of the display device 102 following the cut, such that the most favorable position of the pixel group controller can be selected to enable the largest possible number of pixel groups to remain functional following the cut separating the cut-out display device 102 from the remainder of the sheet 100.

Returning now to the present example illustrated in FIG. 2, it has been established above that certain pixel group controllers are still addressable by the display controller 235 through the intact bus lines 236. Some of these pixel group controllers 240 (again only one of these pixel group controllers is indicated by a reference numeral) are associated with pixel groups 221 that have been cut through. As illustrated in FIG. 2, these pixel groups remain partially functional. In FIG. 2, pixels that are controllable by the display controller 235, via the pixel group controllers, are indicated as white, while those that are, following the cut, beyond control of the display controller 235 are indicated as black. The addressable portion of the cut-out display device 102 thus corresponds to the area having white pixels.

According to the present invention, each pixel group controller 240 is adapted to determine the locations of functional pixels in its associated pixel group 221 and to communicate these locations to the display controller 235 via the bus lines 236. This mapping procedure enables the display controller to adapt the image data to the addressable display indicated by the white pixels in FIG. 2.

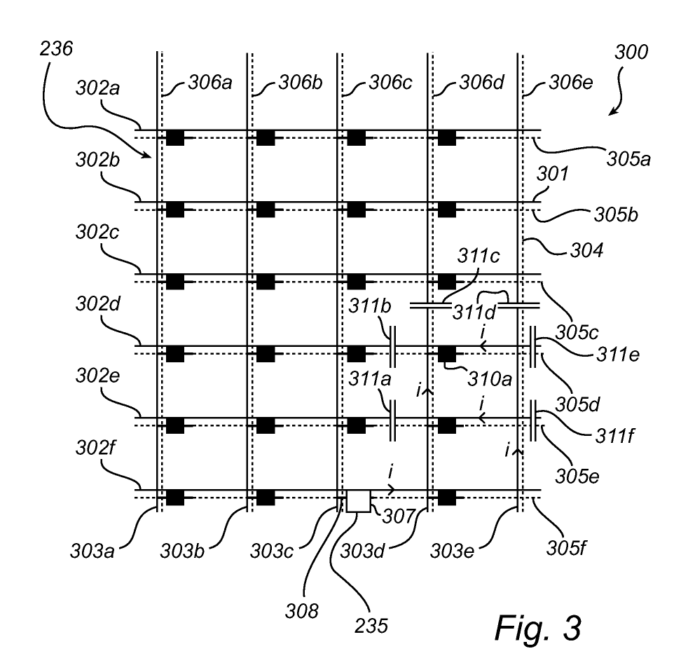

FIG. 3 schematically illustrates a robust communication bus structure 300 for enabling robust communication between the display controller and the pixel group controllers.

In FIG. 3, a communication bus 236 having two bus lines (such as the data line and the clock line in an exemplary simple serial bus) in the form of a first conductive grid 301 indicated by the solid grid lines in rows 302a-f and columns 303a-e, and a second conductive grid 304 indicated by the dotted grid lines in rows 305a-f and columns 306a-e. The first 301 and second 304 conductive grids, representing different bus lines in the communication bus 236, are electrically separated from each other.

This kind of bus configuration may be accomplished in various ways depending on the substrate which is utilized for the cut-to-measure display device 102. For substrates provided in the form of rigid or flexible circuit boards, the first 301 and second 304 conductive grids may be provided in different conductor layers and the connection points for connecting the pixel group controllers to the communication bus may be realized as vias. Such a circuit board layout can readily be designed by a person skilled in the art. In the following, the robust communication bus 236 configuration of FIG. 3 will, however, be described for the case when the display device is based on a woven textile.

In this case, the rows 302a-f and 305a-f are formed by conductive weft yarns and the columns 303a-e and 306a-e are formed by conductive warp yarns. From the second conductive grid 304 formed in a lower layer of the multi-layered interwoven textile, loops are formed in the conductive weft, resulting in the indicated connection points 307 within each area defining a pixel group (only one loop connection point is indicated by a reference numeral to avoid cluttering the figure). Between one of these connection points 307 and a corresponding connection point 308 of the first conductive grid 301 formed in the upper layer of the textile, the display controller 235 is connected. Between each of the other connection points, pixel group controllers 310 (once again, only one of these are indicated by reference numerals) are connected.

In order to demonstrate the robustness of this communication bus 236 configuration, a situation will now be illustrated which corresponds to the display device being cut to measure while the pixel group controllers 310 are connected to the display controller 235 via the first and second conductive grids 301, 304.

With continued reference to FIG. 3, cuts are made in the display device 102 on several sides of a pixel group controller 310, more specifically, cuts 311a-f are made through grid lines 302e and 305e, 302d and 305d, 303d and 306d, and 303e and 306e, respectively at the indicated locations. As illustrated in FIG. 3 the pixel group controller 310 would still be addressable by the display controller 235, with several remaining current paths, as indicated by arrows and the letter i in FIG. 3.

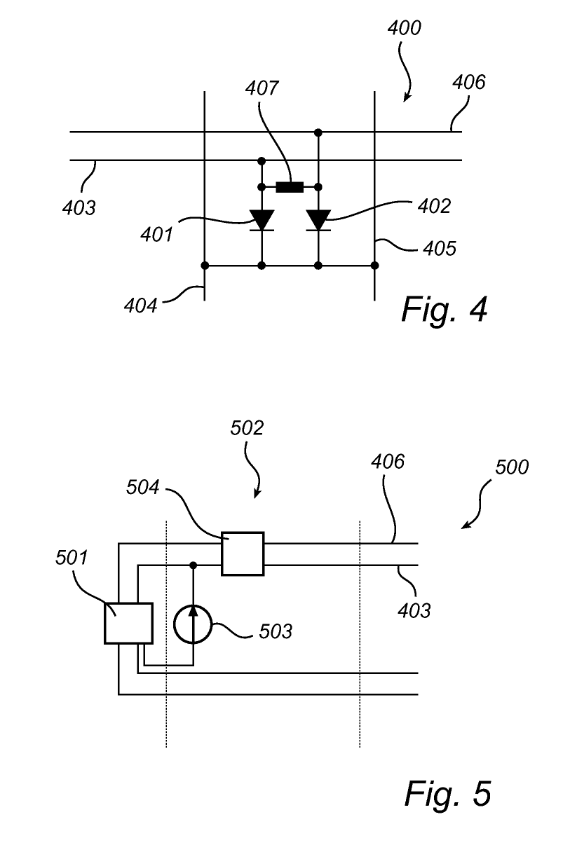

Turning now to FIG. 4, which schematically illustrates an exemplary pixel configuration for the cut-to-measure display 102 in FIG. 2, the pixel 400 is shown to include a first sub-pixel 401 and a second sub-pixel 402. The sub-pixels 401, 402 are, in the present example, provided in the form of light-emitting diodes (LEDs).

The first LED 401 is connected between a first row selection line 403 and the two column selection lines 404, 405, and the second LED 402 is connected between a second row selection line 406 and the same two column selection lines 404, 405. A resistor 407 is connected between the two LEDs 401, 402 on the row selection line side thereof.

Through this pixel structure both electrical and mechanical redundancy is obtained. Electrically, if one of the sub-pixels, say LED 401 were to fail, then the other sub-pixel 402 will be accessible. Furthermore, this structure has a high degree of mechanical redundancy. In the case of the cut-to-measure display 102, in which the pixel 400 is comprised, being based on a textile, there are three points of mechanical failure that can occur within the pixel 400. The first is failure with the connection to the bus line. The second is bus line failure. The third is a multiple connection/bus failure with an electrical failure. This design gives redundancy with respect to all of these modes of failure. By using two LEDs instead of one per pixel, a connection failure with one diode to the bus will not result in the loss of the pixel. By using two bus lines, failure of one bus line will not result in failure of the pixel. Finally, by connecting a resistor between the two LEDs, if one LED losses its functionality, and the other loses its connection or loses its bus line, this LED can be still turned on through applying a drive current through the resistor (applying a drive current to the other bus line).

A suitable driving scheme for the pixel 400 in FIG. 4 will now be described with reference to FIG. 5, schematically illustrating a simplified exemplary pixel group controller including a single row driver.

In FIG. 5, a simplified pixel group controller 500 is shown, which is configured to control a single pixel (one row and one column). Obviously, a pixel group controller is typically configured to control a much larger number of pixels.

The pixel group controller 500 in FIG. 5 comprises a microprocessor 501 and a row driver 502 including a current source 503 and a row switch 504. The microprocessor is configured to control the current source 503 and the row switch 504. When the pixel (not shown) which is controlled by the exemplary pixel group controller 500 is addressed, the microprocessor 501 controls the current source 503 to supply a current to an input of the row switch 504. The row switch 504 toggles between the first row selection line 403 (see FIG. 4) and the second row selection line 406 (see FIG. 4). In this manner, each LED 401, 402, referring to FIG. 4, in the pixel will be turned on 50% of the time. If one of the LEDs 401 is broken, the other LED 402 will be driven through the resistor 407, via the first row selection line 403, during a first cycle and directly, via the second row selection line 406, during a second cycle.

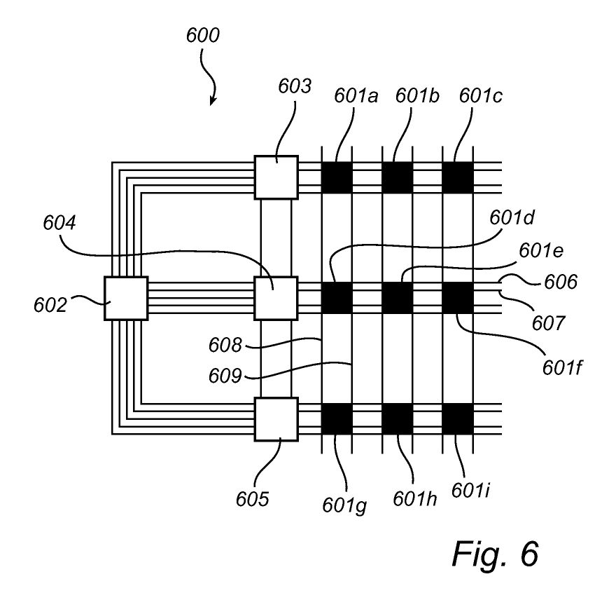

In FIG. 6, a pixel group controller 600 having the same basic configuration as the single pixel controller 500 shown in FIG. 5 has been illustrated in a more realistic configuration, in which it is shown to control a group of 3×3 pixels 601a-i of the kind illustrated in FIG. 4.

The pixel group controller 600 in FIG. 6 comprises a microprocessor 602 which is connected to and adapted to control three row drivers 603-605. When selecting a certain pixel, such as the center pixel 601e, the microprocessor 602 activates the center row driver 604, whereby a current is permitted to alternatingly flow in the first and second row selection lines 606, 607, respectively, associated with the center row driver 604. Furthermore, the center pixel 601e is addressed by also connecting its associated column selection lines 608, 609 to a current sink, thereby causing the current to alternatingly flow through the two LEDs (not shown) comprised in the addressed pixel 601e.

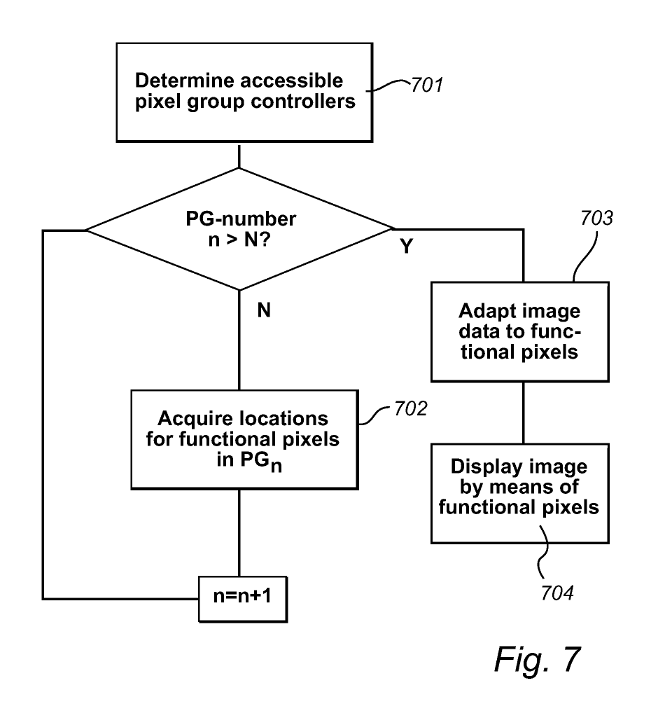

A method according to the invention for controlling the cut-to-measure display device 102 will now be described with reference to the schematic flow-chart in FIG. 7, and to the schematic illustration of the cut-to-measure display device 102 in FIG. 2.

In a first step 701, the display controller 235 determines which pixel group controllers 240 are accessible through the communication bus 236.

Subsequently, in step 702, locations for functional pixels (marked as white in FIG. 2) in a pixel group 221 associated with an accessible pixel group controller 240 are acquired from each accessible pixel group controller. In order to perform this mapping of the total display 102, the display controller 235 successively instructs each pixel group controller to perform a mapping sequence in its associated pixel group. After having determined which pixels are functional within its pixel group, and the locations of these pixels, the pixel group controller communicates this information, the pixel map for the pixel group, to the display controller 235 via the communication bus 236.

When such a pixel group map has been acquired by the display controller 235 for each accessible pixel group controller 240 (pixel group 221), the display controller 235 adapts, in step 703, image data indicative of an image to be displayed by the display device 102 for the determined pixel map.

Finally, in step 704, the display controller 235 controls the functional pixels to display the desired image utilizing the image data adapted in step 703.

The person skilled in the art realizes that the present invention by no means is limited to the preferred embodiments described above. For example, the pixels may include more than two light-emitting devices, in particular the pixels may, for example, comprise two groups of differently colored light-emitting devices.

1. A cut-to-measure display device comprising:
a plurality of pixel groups, at least one pixel group of said plurality of pixel groups including:
a plurality of individually controllable functional pixels, each pixel comprising
a first sub-pixel addressable by a first row selection line and each of a first and a second column selection lines; and
a second sub-pixel addressable by a second row selection line and each of a first and a second column selection lines; and
a pixel group controller adapted to control each of said pixels in the pixel group;
a display controller configured to control said pixels, via said pixel group controllers, to display an image corresponding to pre-determined image data; and
a communication bus comprising a plurality of bus lines interconnecting said display controller with each of said pixel group controllers (230), wherein:
each pixel group controller is configured to:
determine locations of said functional pixels in its associated pixel group; and
communicate information indicative of said locations of said functional pixels to said display controller to enable adjustment of said image data for display of said image by means of said functional pixels.

2. A cut-to-measure display device according to claim 1, wherein each of said bus lines is formed by a set of mutually interconnected conductors distributed across said display device to enable a robust interconnection between said display controller and said pixel group controllers.

3. A cut-to-measure display device according to claim 1, wherein said communication bus is a serial bus having a clock line, and a data line.

4. A cut-to-measure display device according to claim 1, wherein each pixel group controller has pre-determined bus address.

5. A cut-to-measure display device according to claim 1, wherein each pixel comprises at least one light-emitting device.

6. (canceled)

7. A cut-to-measure display device according to claim 6, wherein:
each of said sub-pixels comprises a light-emitting device; and
said pixel further comprises a resistor connecting said first and second row selection lines.

8. A cut-to-measure display device according to claim 6, wherein said pixel group controller is configured to apply a control voltage alternatingly to said first and second row selection lines, thereby alternatingly selecting said first and second sub-pixels comprised in said pixel.

9. A cut-to-measure display device according to claim 1, wherein said pixel group controller comprises a plurality of pixel drivers, each being configured to drive a sub-set of the pixels in said pixel group.

10. A cut-to-measure display device according to claim 1, wherein:
said display device comprises a textile formed from interwoven electrically conductive and non-conductive yarns;
each of said bus lines is formed by a matrix of conductive warp and weft yarns crossing each other such that electrical contact is achieved there between; and
said row and column selection lines, respectively, are formed by conductive warp and weft yarns crossing each other such that said warp and weft yarns are electrically isolated from each other.

11. A method for controlling a cut-to-measure display device having a plurality of pixel groups, at least one pixel group of said plurality of pixel groups including a plurality of individually controllable functional pixels, each pixel comprising a first sub-pixel addressable by a first row selection line and each of a first and a second column selection lines, and a second sub-pixel addressable by a second row selection line and each of a first and a second column selection lines; and a pixel group controller adapted to control each of said pixels in the pixel group; a display controller configured to control said pixels, via said pixel group controllers, to display an image corresponding to pre-determined image data; and a communication bus comprising a plurality of bus lines interconnecting said display controller with each of said pixel group controllers, said method comprising the steps of:
for each pixel group, determining whether its associated pixel group controller is addressable;
for each of said addressable pixel group controllers, acquire information indicative of functional pixels in its associated pixel group;
adjusting said image data based on said information; and
controlling said functional pixels, via said addressable pixel group controllers, to display said image.

12. (canceled)
